(19) United States
(12) Patent Application Publication
(10) Pub. No.: US 2004/0207266 A1
(43) Pub. Date: Oct. 21, 2004

(54) Standby electrical power generation and storage system and method

(76) Inventors: Stephen G. Abel, Chandler, AZ (US); Calvin C. Potter, Mesa, AZ (US); George J. Klupar, Phoenix, AZ (US)

Correspondence Address: HONEYWELL INTERNATIONAL, INC., Law Dept. AB2, P.O. Box 2245, Morristown, NJ, 07962-9806, US

(21) Appl. No.: 10/417,538

(22) Filed: Apr. 16, 2003

(51) Int. Cl. H02J 1/00

(52) U.S. Cl. 307/80

(57) ABSTRACT

A system and method of providing standby electrical power to a power distribution system in the event of a transient or sustained unavailability of a main source of electrical power that includes one or more energy storage flywheels, a battery and a generator. The energy storage flywheels are used to absorb relatively short transients and are the first line of defense for sustained losses of the main power source. Thus, the rate of backup battery degradation is reduced, which reduces the likelihood of shortened battery life, and reduces the need for, and/or number of, time consuming and costly battery replacements.

### FIELD OF THE INVENTION

The present invention relates to electrical power generation systems and, more particularly, to a system of electrical power generation and storage that has one or more flywheels and that can be used in space, vehicle, or terrestrial applications. The system may be used to store electrical energy and used as a standby electrical source in the event of a transient or sustained unavailability of a main source of electrical power.

### BACKGROUND OF THE INVENTION

Many satellites and other space vehicles, as well as some terrestrial vehicle applications, such as seagoing vessels, include a main source of electrical power and a standby, or backup, source of electrical power. The main source of electrical power may include one or more photovoltaic arrays, in the case of a satellite, or one or more engine-driven or turbine-driven generators, in the case of seagoing vessels. The standby electrical power source may include a battery, and may additionally include one or more energy storage flywheels, and/or one or more separate engine-driven or turbine-driven generators.

In many cases, the main electrical power source is used to supply electrical power to the vehicle's main electrical distribution system, and the standby electrical power source is used to supply electrical power in the event the main electrical power source is unavailable or is unable to supply sufficient electrical power for a sustained or transient period of time. In some instances, the standby electrical power source is either a battery alone or, if used in combination with other electrical power sources, is the primary and/or initial electrical power supply for the standby power source.

Over the lifetime of a vehicle, it may experience a number of instances in which the main electrical power source is unavailable or unable, either for relatively short transient time periods or for sustained periods of time, to supply sufficient electrical power. In such instances, the standby electrical power source may be used to supply some or all of the electrical power to the vehicle electrical distribution system and, as was noted above, the battery is used as the primary source of this electrical power. When the battery supplies electrical power, it discharges at a rate dependent on the electrical load it is supplying, and continues discharging, in most instances, until the main electrical power source is once again available or able to supply sufficient electrical power. Thereafter, when the battery is no longer used to supply electrical power, it may be charged back up to capacity.

The useful life of a battery is affected by various factors. Among these factors is the number, magnitude, and duration of the charge/discharge cycles it undergoes. For example, if a certain type of battery is exposed to numerous short-duration charge/discharge cycles, this can result in accelerated degradation and/or a shortening in its useful life. Once a battery has appreciably degraded, it should be replaced. When replacing the battery, the vehicle into which it is installed may need to be taken out of service, thereby reducing its usefulness. Moreover, battery replacement can be a time consuming and potentially costly operation.

Hence, there is a need for a system and method for providing a standby electrical power source in the event of a transient or sustained unavailability of a main source of electrical power that reduces the rate of battery degradation and/or reduces the likelihood of shortened battery life, and/or does not reduce vehicle usefulness, and/or reduces the need for, and/or number of, time consuming and costly battery replacements. The present invention addresses one or more of these needs.

### SUMMARY OF THE INVENTION

The present invention provides a system and method for providing standby electrical power in the event of a transient or sustained unavailability of a main source of electrical power. One or more energy storage flywheel systems are used.

In one embodiment, and by way of example only, a system for providing electrical power to a power distribution system includes a generator, a battery, and one or more energy storage flywheel systems. The generator is selectively operable to supply electrical power to the power distribution system. The battery is selectively operable to draw electrical power from, or supply electrical power to, the power distribution system. Each of the energy storage flywheel systems is selectively operable to draw electrical power from, or supply electrical power to, the power distribution system. The controller is adapted to receive one or more signals representative of an electrical state of the power distribution system and is operable, in response thereto, to determine the electrical state of the power distribution system and, to selectively electrically couple one or more of the energy storage flywheel systems, or the battery, or the generator to the power distribution system, based at least in part on the determined electrical state.

In another exemplary embodiment, a method of providing a standby source of electrical power to a power distribution system includes providing a generator, a battery, and one or more energy storage flywheel systems. The generator is selectively operable to supply electrical power to the power distribution system. The battery and the energy storage flywheel systems are each selectively operable to draw electrical power from, or supply electrical power to, the power distribution system. An electrical state of the power distribution system is monitored and, based at least in part thereon, a determination is made as to whether a standby source of electrical power is needed to supply electrical power to the power distribution system. When it is determined that a standby source of electrical power is needed, one or more of the energy storage flywheel systems, or the battery, or the generator are electrically coupled to the power distribution system.

Other independent features and advantages of the preferred electrical power generation and storage system and method will become apparent from the following detailed description, taken in conjunction with the accompanying drawings which illustrate, by way of example, the principles of the invention.

### BRIEF DESCRIPTION OF THE DRAWINGS

FIG. 1 is a simplified functional block diagram of an exemplary embodiment of an energy supply and storage system;

FIG. 2 is a perspective view of a physical embodiment of an exemplary satellite system that may incorporate the system of FIG. 1;

FIG. 3 is a block diagram of an exemplary embodiment an energy storage flywheel system that may be incorporated into the system of FIG. 1; and

FIGS. 4-8 are state diagrams illustrating exemplary processes implemented by various portions of the system illustrated in FIG. 1 to implement store and supply standby electrical power.

### DETAILED DESCRIPTION OF A PREFERRED EMBODIMENT

Before proceeding with a detailed description, it is to be appreciated that the described embodiment is not limited to use in conjunction with a spacecraft. Thus, although the present embodiment is, for convenience of explanation, depicted and described as being implemented in a satellite, it will be appreciated that it can be implemented in other systems and environments, both terrestrial and extraterrestrial including, for example, land-based power systems and power systems on sea-going vessels such as surface ships and submarines.

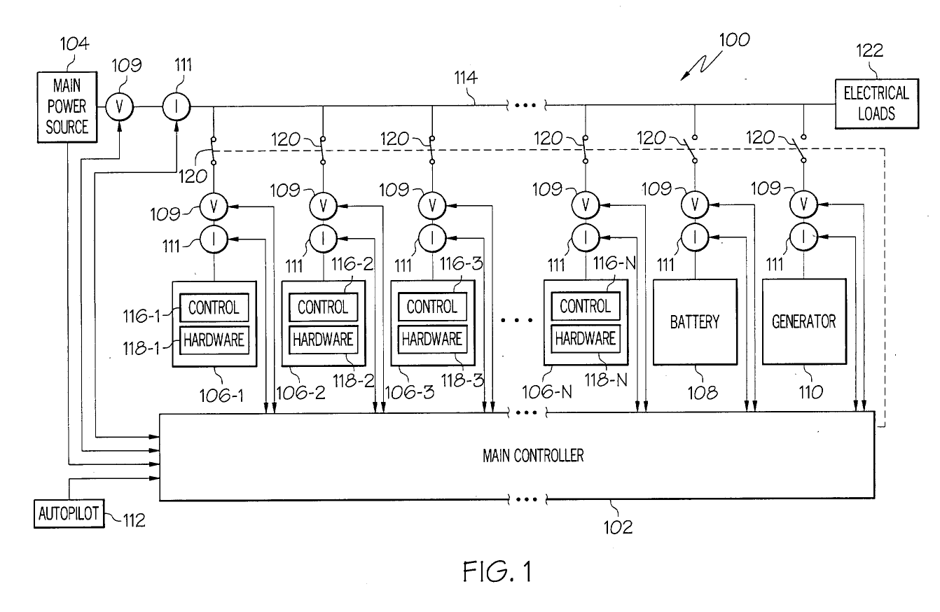

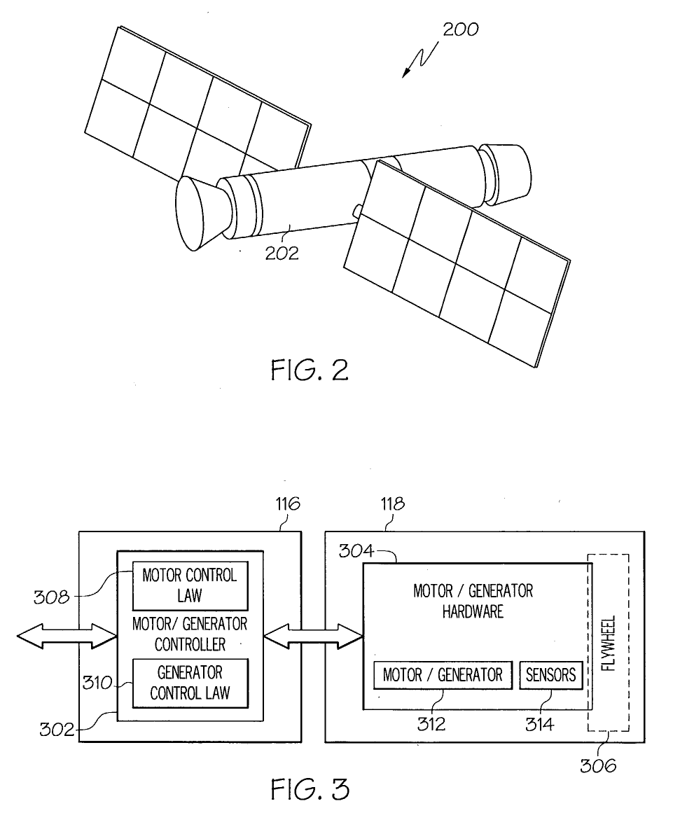

Turning now to the description and with reference first to FIG. 1, a functional block diagram of an exemplary electrical power generation and distribution system 100 for a spacecraft is shown. The system 100 includes a main controller 102, a main electrical power source 104, a plurality of energy storage flywheel systems 106 (106-1, 106-2, 106-3, . . . 106-N), a battery 108, and a backup generator 110. A perspective view of an exemplary physical embodiment of a spacecraft 200 that may use the system 100 is illustrated in FIG. 2.

The main controller 102 receives mission commands from, for example, an earthbound station or its onboard autopilot and payloads 112, monitors the state of one or more power distribution buses 114, and in response controls the operation of the flywheel systems 106, the battery 108, and the generator 110. In response to the torque commands, the flywheel systems 106 may be controlled to induce appropriate attitude torques in the spacecraft, and thereby control spacecraft attitude. In addition, the main controller 102 determines the state of the power distribution bus 114 using, at least partially, signals provided from one or more voltage sensors 109 and one or more current sensors 111, and may also monitor the state of the main power source 104. Depending upon the determined state of the power distribution bus 114, the main controller 102 controls the operation of the flywheels 106, the battery 108, and the generator 110, which make up a standby electrical power source for the system 100, to either supply electrical energy to, or, in the case of the flywheels 106 and the battery 108, to draw electrical energy from, the electrical distribution system bus 114. A more detailed description of the process the main controller 102 implements to control electrical power supplied to and drawn from the flywheels 106, the battery 108, and the generator 110 is provided further below.

A plurality of controllable switches 120 are used to selectively electrically couple each of the flywheel systems 106, the battery 108, and the generator 110 to the power distribution bus 114. The switches 120 may be any one of numerous switching devices now known, or developed in the future, for providing this functionality including, but not limited to circuit breakers. The switches 120 are preferably remotely controllable and, in the depicted embodiment, are positioned between open and closed positions under the control of the main controller 102. As illustrated in FIG. 1, in the open position each switch 120 electrically decouples its associated device from the power distribution bus 114, and in the closed position electrically couples its associated device to the power distribution bus.

The main electrical power source 104, as its name connotes, is the main source of electrical power to the power distribution buses 114 and any electrical loads 122 electrically coupled thereto. In the depicted embodiment, in which the system 100 is implemented in a spacecraft, the main electrical power source 104 is one or more solar panels, each of which includes an array of solar cells to convert light energy into electrical energy. When implemented in a terrestrial environment, it will be appreciated that the main electrical power source 104 may be, for example, a power grid or portion thereof, which may be subject to brown out and/or blackout events. The solar panels 104 may be attached to the satellite itself or to fixed or moveable structures that extend from the satellite. When the spacecraft 200 is positioned such, that it does not receive sunlight, such as, for example, when it is in the Earth's shadow, a backup electrical power source is needed. As was noted above, in addition to providing attitude control, the flywheel systems 106, in combination with the battery 108 and the generator 110, function as a standby power source for the system 100.

The system 100 includes N number of energy storage flywheel systems 106 (106-1, 106-2, 106-3, . . . 1-6-N). The system 100 may be configured so that all of the flywheel systems 106 are active, or so that only some of the flywheel systems 106 are active, while one or more of the, remaining flywheel systems 106 are in a standby, inactivated state. The number of flywheel systems 106 that are active and/or inactive may vary, depending on system requirements.

The flywheel systems 106 each include a flywheel control module 116 (116-1, 116-2, 116-3, . . . 116-N) and flywheel hardware 118 (118-1, 118-2, 118-3, . . . 118-N). The flywheel control modules 116 are each in operable communication with the main controller 102. The main controller 102, as was noted above, supplies torque control commands to the each of the flywheel control modules 116. In turn, the flywheel control modules 116 control the relative attitudes and angular velocities of the associated flywheel hardware 118 to effect attitude control of the spacecraft 200. The flywheel control modules 116 also respond to commands from the main controller 102 to control the operation of the associated flywheel hardware 118 in either a motor mode or a generator mode, and may additionally control the rotational acceleration of the associated flywheel hardware 118 in each mode.

Thus, as shown more clearly in FIG. 3, each flywheel control module 116 includes at least a motor/generator controller 302, and each flywheel hardware module 118 includes at least motor/generator hardware 304 and an energy storage flywheel 306. The motor/generator controller 302 is configured to selectively implement either a motor control law 308 or a generator control law 310. The motor/generator controller 302 also receives various feedback signals from the motor/generator hardware 304. At least some of the feedback signals received by the motor/generator controller 302 are representative of the motor/generator hardware 304 response to the supplied control signals. The motor/generator controller 302 supplies one or more of the feedback signals it receives from the motor/generator hardware 304 to the main controller 102. The motor/generator hardware 304 includes a motor/generator 312 and one or more sensors 314. The motor/generator 312 may be any one of numerous motor/generator sets known now, or in the future, and includes a main rotor that is coupled to the rotor of the flywheel 306. The sensors 314 include one or more rotational speed sensors, one or more temperature sensors, and one or more commutation sensors.

When commanded to do so by the main controller 102, the motor/generator controller 302 implements the motor control law 308 and the motor/generator 312 is operated in a motor mode. During operation in the motor mode, the motor/generator 312 spins up the flywheel 306, to store rotational kinetic energy. Conversely, when the main controller 102 commands the motor/generator controller 302 to implement the generator control law 310, the motor/generator 312 is operated in a generator mode. During its operation in the generator mode, the motor/generator 312 spins down the flywheel 306, converting the flywheel's stored rotational kinetic energy to electrical energy.

Returning once again to FIG. 1, the battery 108 may be any one of numerous rechargeable type of batteries now known, or developed in the future, including, but not limited to, a lead-acid battery, a nickel-cadmium battery, a lithium ion battery, and a nickel metal hydride battery. Similarly, the generator 110 may be any one of numerous types of generators now known, or developed in the future, that may be used to generate either AC or DC electrical power. Non-limiting examples of the various generator types include a brushed DC generator, a brushless AC generator, or a brushless DC generator. In addition, the generator 110 may be driven by any one of numerous motive power sources now known, or developed in the future. Non-limiting examples of the various motove power sources include diesel, or other fossil fuel powered engines, fuel cells, or a nuclear isotope heated Brayton cycle turbo-compressor engine. In addition to the voltage sensors 109 and current sensors 111 on the power distribution bus 114, voltage 109 and current 111 sensors are also provided to sense at least the electrical output of each of the flywheel systems 106, the battery 108, and the generator 110, and supply signals representative thereof to the main controller 102. One or more temperature sensors 113 are also preferably provided to sense the temperature of the battery 108 and supply signals representative thereof to the main controller 102.

When the main electrical power source 104 is supplying electrical power to the power distribution bus 114, as is shown in FIG. 1, the active energy storage flywheel systems 106 are electrically coupled to the power distribution bus 114 via their respective closed switches 120. Conversely, the battery 108 and the generator 110 are electrically decoupled from the power distribution bus 114 via their respective open switches 120. As will be described in more detail below, with this configuration, the energy storage flywheels 106 are used to supply electrical power for relatively short duration transients on the power distribution bus 114. In addition, the main controller 102 continuously monitors the state of the flywheels 106 and the battery 108 using at least the above-mentioned various voltage 109 and current 111 sensors, and periodically configures the system 100 to spin up the flywheels 106, and to electrically couple the battery 108 to the power distribution bus 114 to trickle charge the battery 108.

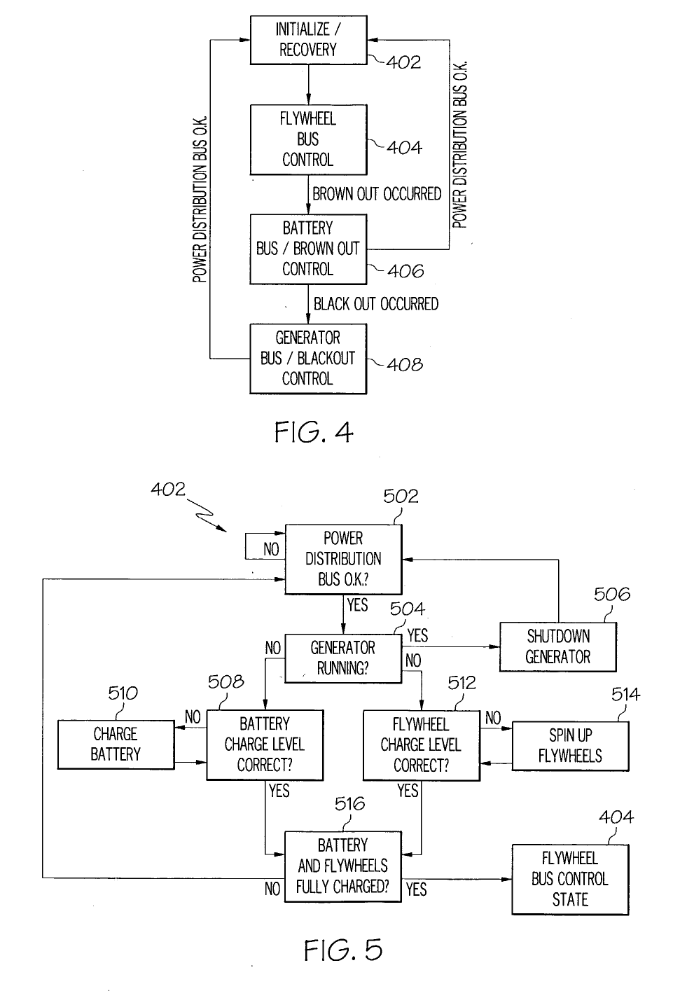

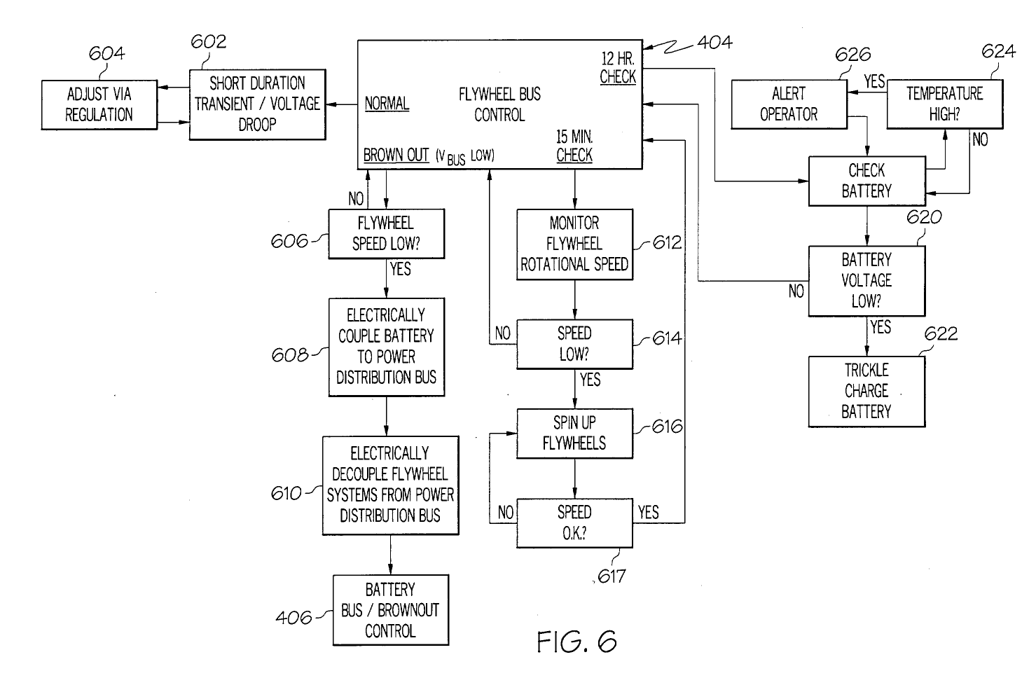

The main controller 102, as was noted above, controls the power supplied to and drawn from the flywheels 106, the battery 108, and the generator 110. A detailed description of the process the controller 102 implements to provide this control will now be provided. In doing so, reference should be made to FIGS. 4-8, in combination with FIG. 1, which are exemplary state diagrams illustrating the process implemented by the main controller 102. It is noted that the numbers in parentheses in the following description correlate to the reference numerals associated with each of the depicted states. It will also be appreciated that the particular state transitions depicted and described are merely exemplary of particular preferred embodiments, and that others could be implemented.

Referring first to FIG. 4, the main controller 102 enters an INITIALIZE/RECOVERY state (402) upon system startup and then transitions to a FLYWHEEL BUS CONTROL state (404). The main controller 102 will remain in the FLYWHEEL BUS CONTROL state (404) until the system 100 is shutdown, or it determines that a brown out has occurred on the power distribution bus 114. In this latter instance, the main controller 102 transitions to a BATTERY BUS CONTROL/BROWN OUT state (406) until it determines that the power distribution bus 114 has recovered or it determines that a blackout has occurred on the power distribution bus 114. If the power distribution bus 114 has recovered, the system 100 transitions back to the INITIALIZE/RECOVERY state (402). If, however, a system blackout has occurred, and persists for a time period, the main controller 102 transitions to a GENERATOR BUS CONTROL/BLACKOUT state (408). The main controller 102 will remain in the GENERATOR BUS CONTROL state (408) until it determines that the power distribution bus 114 has recovered. At that point, the main controller 102 then transitions to the INITIALIZE/RECOVERY state (402). Each of these states will now be described in more detail.

Referring first to FIG. 5, which is a state diagram representation of the INITIALIZE/RECOVERY state (402), it is seen that when the main controller 102 enters this state, it first determines whether the power distribution bus 114 has fully recovered (502) and, if so, determines whether or not the generator 110 is running (504). If the generator 110 is running, the main controller 102 shuts the generator down (506), and transitions back to the initial state (502). If the generator 110 is not running, then the main controller 102 determines the charge state of the battery 108 (508) and of the active flywheel systems (512). If the battery 108 needs to be charged, the main controller 102 will electrically couple the battery 108 to the power distribution bus 114 and charge the battery (510) until it reaches an appropriate charge state. Similarly, if the rotational speed of the active flywheels 308 indicates that the one or more should be spun up, the main controller 102 will configure the appropriate flywheel systems 106 as motors (514) until each reaches an appropriate rotational speed. Once the main controller 102 determines that both the battery 108 and each of the flywheel systems 106 are storing a sufficient amount of energy (516), it then transitions to the FLYWHEEL BUS CONTROL state (404).

The FLYWHEEL BUS CONTROL state (404) is preferably the state that the main controller 102 will be in for a majority of the time during system operations. In this state (404), if a relatively short transient and/or voltage droop is sensed on the power distribution bus 114 (602), the flywheel systems 106 are controlled to absorb to the transient (604, 606). However, if a transient occurs on the power distribution bus 114 that is of such a magnitude and/or duration that the rotational speed of the active flywheels 308 falls below a predetermined magnitude (606), the voltage on the power distribution bus 114 may fall below a predetermined voltage magnitude resulting in a “brownout” condition. The value of this predetermined voltage magnitude may vary. If this occurs, the main controller 102 electrically couples the battery 108 to (608), and electrically decouples the flywheel systems 106 (610) from, the power distribution bus 114. The main controller 102 then transitions to the BATTERY BUS CONTROL/BROWN OUT state (406), which is described in more detail further below.

While the main controller 102 is in the FLYWHEEL BUS CONTROL state (404), it also periodically checks the state of both the active flywheel systems 106 and the battery 108. In particular, in the depicted embodiment, the main controller 102 checks the rotational speed of each flywheel 308 approximately every 15 minutes (612). It will be appreciated that this time may vary. If the rotational speed is at or below a first predetermined magnitude (614), the flywheel system is configured to operate in the motor mode and spin up the associated flywheel 308 (616) until it reaches a second predetermined rotational speed (617). If the rotational speed is above the first predetermined rotational speed magnitude, then the flywheel system 106 remains configured in the generator mode.

In the depicted embodiment, the main controller 102 checks the battery 108 approximately every 12 hours (618), though it will be appreciated that this time may also vary. In particular, the main controller 102 receives signals representative of battery voltage (620) and, if it is low, electrically couples the battery 108 to the power distribution bus 114 to trickle charge the battery 108 (622). The main controller also receives signals representative of battery temperature (624) and, if above a predetermined temperature magnitude, provides an alert (626) to warn one or more operational personnel, so that corrective action can be taken.

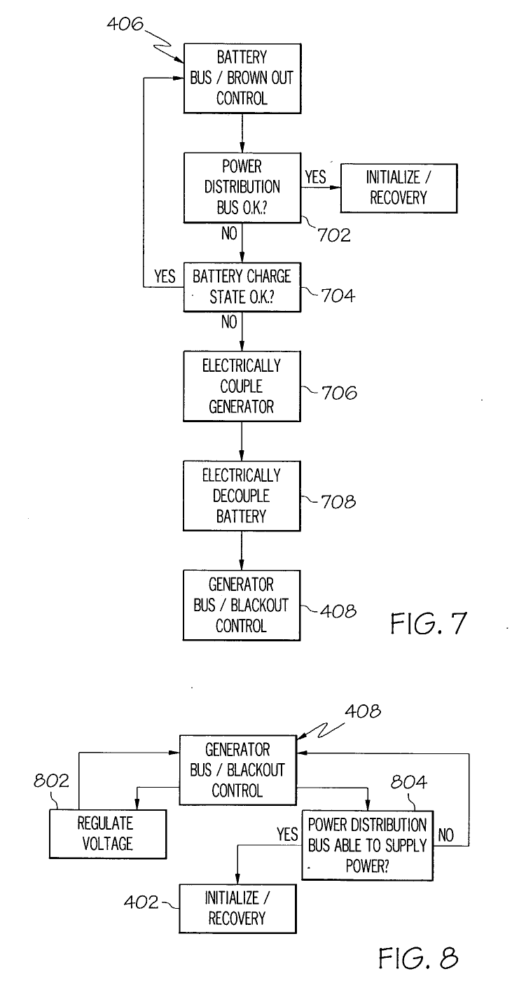

Turning now to FIG. 7, the BATTERY BUS CONTROL/BROWN OUT state (406) will now be described. As was noted above, the main controller 102 transitions to this state if a brownout condition occurs. During this state, the battery 108 supplies power to the power distribution bus 114 until the main power source 104 is restored or until the battery is sufficiently depleted. Thus, the main controller 102 monitors the power distribution bus 114 (702) and the charge state of the battery 108 (704). If the main power source 104 is restored while in this state (406), then the main controller 102 transitions to the INITIALIZE/RECOVERY state (402). However, if the main power source 104 is not restored and the main controller 102 determines that the battery 108 is discharged to a predetermined charge level (704), which may vary, a “blackout” condition exists and the main controller 102 electrically couples the generator 110 to the power distribution bus (706) and electrically decouples the battery 108 (708). The main controller 102 then transitions to the GENERATOR BUS CONTROL/BLACKOUT state (408).

The GENERATOR BUS CONTROL/BLACKOUT state (408) is shown in FIG. 8. In this state, the main controller 102 controls the generator 110 to supplies power to, and regulate the voltage magnitude on, the power distribution bus (802). The main controller 102 also monitors the power distribution bus 114 (804) in this state. When the main controller 102 determines that the main power source 104 is restored, it then transitions to the INITIALIZE/RECOVERY state (402).

In the preceding, the main controller 102 was described as implementing both attitude control and power system control. It will be appreciated, however, that the controller used to implement the above-described system operational configurations could be a physically separate controller that is used only for such power system configurations. In addition, the controller could be used to implement other functions, either in addition to, or instead of, attitude control.

The system and method described herein for providing standby electrical power to a power distribution bus 114 in the event of a transient or sustained unavailability of the main power source 104 reduces the rate of backup battery degradation. The system and method additionally reduces the likelihood of shortened battery life, and reduces the need for, and/or number of, time consuming and costly battery replacements. The system and method are additionally implemented to improve overall system reliability and efficiency.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A system for providing electrical power to a power distribution system, comprising:
a generator selectively operable to supply electrical power to the power distribution system;
a battery selectively operable to draw electrical power from, or supply electrical power to, the power distribution system;
one or more energy storage flywheel systems selectively operable to draw electrical power from, or supply electrical power to, the power distribution system; and
a controller adapted to receive one or more signals representative of an electrical state of the power distribution system and operable, in response thereto, to (i) determine the electrical state of the power distribution system and (ii) selectively electrically couple one or more of the energy storage flywheel systems, or the battery, or the generator to the power distribution system, based at least in part on the determined electrical state.

2. The system of claim 1, wherein:
the controller is further operable to (i) determine an amount of energy stored in each energy storage flywheel system and (ii) issue a flywheel system operational configuration command to each energy storage flywheel system based at least in part on the determined amount of stored energy; and
each energy storage flywheel system is coupled to receive its respective flywheel system operational configuration command and is operable, in response thereto, to operate in either a motor mode or a generator mode.

3. The system of claim 2, further comprising:
one or more flywheel rotational speed sensors, each speed sensor coupled to one of the energy storage flywheel systems and operable to determine a rotational speed of its associated flywheel system,
wherein the controller is coupled to receive each rotational speed signal and is operable to determine the amount of energy stored in each energy storage flywheel system based at least in part thereon.

4. The system of claim 2, wherein each energy storage flywheel system:
draws electrical power from the power distribution system when operating in the motor mode; and
supplies electrical power to the power distribution system when operating in the generator mode.

5. The system of claim 2, wherein the controller is configured to determine the amount of energy stored in each of the energy storage flywheels at a predetermined time interval.

6. The system of claim 5, wherein the predetermined time interval is approximately every fifteen minutes.

7. The system of claim 1, wherein the controller is further operable to:
determine a charge state of the battery; and
electrically couple the battery to the power distribution system to draw electrical power therefrom if the determined charge state indicates that the battery needs to be charged.

8. The system of claim 7, wherein the controller is configured to determine the charge state of the battery at a predetermined time interval.

9. The system of claim 8, wherein the predetermined time interval is approximately every twelve hours.

10. The system of claim 7, wherein the controller is further operable to electrically decouple the battery from the power distribution system when the determined charge state indicates that the battery is in a substantially charged state.

11. The system of claim 7, wherein the battery needs to be charged when at least battery voltage is at or below a predetermined voltage magnitude.

12. The system of claim 7, further comprising:
a battery temperature sensor operable to supply a signal representative of battery temperature; and
a battery voltage sensor operable to supply a signal representative of battery voltage,
wherein the controller is coupled to receive the battery temperature signal and the battery voltage signal and is operable, in response thereto, to determine the charge state of the battery based at least in part on battery temperature and voltage.

13. The system of claim 3, wherein the controller electrically couples the energy storage flywheel systems to the power distribution system unless:
(i) the determined electrical state of the power distribution system is a brown out state, and
(ii) the rotational speed of each of the energy storage flywheel systems is at or below a predetermined rotational speed magnitude.

14. The system of claim 13, wherein, when the rotational speed of each of the energy storage flywheel systems is at or below the predetermined rotational speed magnitude, the controller:
(i) electrically couples the battery to the power distribution system, and
(ii) electrically decouples each of the energy storage flywheel systems from the power distribution system.

15. The system of claim 13, further comprising:
a voltage sensor configured to sense power distribution system voltage magnitude and supply a signal representative thereof to the controller,
wherein the controller determines that the electrical distribution system is in a brown out state at least when the power distribution system voltage magnitude is at or below a predetermined voltage magnitude.

16. The system of claim 14, wherein the controller is further operable to:
determine a charge state of the battery; and
when the determined charge state is at or below a predetermined level:
(i) electrically couple the generator to the power distribution system, and
(ii) electrically decouple the battery from the power distribution system.

17. A method of providing a standby source of electrical power to a power distribution system, comprising:
providing a generator that is selectively operable to supply electrical power to the power distribution system;
providing a battery that is selectively operable to draw electrical power from, or supply electrical power to, the power distribution system;
providing one or more energy storage flywheel systems that are each selectively operable to draw electrical power from, or supply electrical power to, the power distribution system;
monitoring an electrical state of the power distribution system;
determining that a standby source of electrical power is needed to supply electrical power to the power distribution system, based at least in part on the electrical state of the power distribution system; and
electrically coupling one or more of the energy storage flywheel systems, or the battery, or the generator to the power distribution system, when it is determined that a standby source of electrical power is needed.

18. The method of claim 17, further comprising:
determining an amount of energy stored in each energy storage flywheel system; and
operating each energy storage flywheel system in either a motor mode or a generator mode, based at least in part on the determined amount of stored energy.

19. The method of claim 18, further comprising:
determining a rotational speed of each energy storage flywheel system; and
determining the amount of energy stored in each energy storage flywheel system based at least in part on the determined rotational speed.

20. The method of claim 18, further comprising:
determining the amount of energy stored in each of the energy storage flywheel systems at a predetermined time interval.

21. The method of claim 20, wherein the predetermined time interval is approximately every fifteen minutes.

22. The method of claim 17, further comprising:
determining a charge state of the battery; and
electrically coupling the battery to the power distribution system to draw electrical power therefrom if the determined charge state indicates that the battery needs to be charged.

23. The method of claim 22, further comprising:
determining the charge state of the battery at a predetermined time interval.

24. The method of claim 23, wherein the predetermined time interval is approximately every twelve hours.

25. The method of claim 22, further comprising:
decoupling the battery from the power distribution system when the determined charge state indicates that the battery is in a substantially charged state.

26. The method of claim 22, wherein the battery needs to be charged when at least battery voltage is at or below a predetermined voltage magnitude.

27. The method of claim 22, further comprising:
determining battery temperature and battery voltage; and
determining the charge state of the battery based at least in part thereon.

28. The method of claim 19, wherein the energy storage flywheel systems are electrically coupled to the power distribution system unless:
(i) the determined electrical state of the power distribution system is a brown out state, and
(ii) the determined rotational speed of each of the energy storage flywheel systems is at or below a predetermined rotational speed magnitude.

29. The method of claim 28, further comprising, when the determined rotational speed of each of the energy storage flywheel systems is at or below the predetermined rotational speed magnitude:
(i) electrically coupling the battery to the power distribution system; and
(ii) electrically decoupling each of the energy storage flywheel systems from the power distribution system.

30. The method of claim 28, further comprising:
determining power distribution system voltage magnitude,
wherein the electrical distribution system is in a brown out state at least when the power distribution system voltage magnitude is at or below a predetermined voltage magnitude.

31. The method of claim 28, further comprising:
determining a charge state of the battery; and
when the determined charge state is at or below a predetermined level:
(i) electrically coupling the generator to the power distribution system, and
(ii) electrically decoupling the battery from the power distribution system.
